(19) United States
(12) Patent Application Publication
(10) Pub. No.: US 2018/0149131 A1
(43) Pub. Date: May 31, 2018

(54) POWER GENERATING SYSTEM

(71) Applicant: Abdullah Mohammed ALKHARS, Bozeman, MT (US)

(72) Inventor: Abdullah Mohammed ALKHARS, Bozeman, MT (US)

(21) Appl. No.: 15/365,111

(22) Filed: Nov. 30, 2016

(51) Int. Cl. F03B 13/06; F03B 15/16

(52) U.S. Cl. CPC F03B 13/06; F05B 2220/32; F03B 15/16

(57) ABSTRACT

A power generating system including a movable tank filled configured to move vertically, a piston driven by the movable tank via a piston rod, a first cylinder filled with the liquid, and connected to the piston at a top end and a turbine at a bottom end, wherein the piston reciprocates in the first cylinder pushing the liquid from the first cylinder into the turbine causing the turbine to rotate and produce power, and a stationary tank connected to an outlet of the turbine. The system further includes a second cylinder connected to the movable tank and the first cylinder, and a balloon filled with gas connected to a top portion of the movable tank, wherein the balloon lifts the movable tank from a bottom position to a top position when the movable tank is empty.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### BACKGROUND

### Field of the Disclosure

This disclosure relates generally to a power generating system. More particularly the present disclosure relates to generating power using gravity effect and buoyancy effect.

### Description of the Related Art

Power systems generate power by converting one form of energy such as mechanical, hydraulic, potential energy of water in dam, wind, solar, kinetic, etc. into electric energy. The electrical energy can be used for various purposes such as powering household devices and charging batteries.

A typical hydraulic power plant includes a dam build around a water body. The water passes through pipes to a turbine to rotate the turbine and generate power. In another application, a system can employ a buoyant element floating on a water surface. The buoyant element moves up and down along with a water tide. The movement of the buoyant element is then converted, using a mechanical system and a generator, into electrical energy.

Some power systems burn fossil fuels to produce energy, for example, a coal power plant. Such power plant produce harmful gases that can pollute the air, water, soil causing long term environmental damages.

Although there are several forms of power producing devices, an efficient and pollution free power producing devices are required. For example, devices that can generate power from naturally occurring power sources such as gravity, and buoyancy effect.

### SUMMARY

According to an embodiment of the present disclosure, there is provided a power generating system. The system includes a movable tank filled with a liquid having an inlet and an outlet with a first outlet door configured to move vertically, a piston driven by the movable tank via a piston rod, a first cylinder filled with the liquid, and connected to the piston at a top end and a turbine at a bottom end, wherein the piston reciprocates in the first cylinder pushing the liquid from the first cylinder into the turbine causing the turbine to rotate and produce power, a stationary tank having an inlet and an outlet with a second outlet door, wherein the inlet of the stationary tank is connected to an outlet of the turbine to receive the liquid from the turbine when the movable tank descends, and the outlet of the stationary tank is connected to the inlet of the movable tank to discharge the liquid in the movable tank when the second outlet door is open. The system further includes a second cylinder connected to the movable tank and the first cylinder, wherein the second cylinder receives the liquid from the outlet of the movable tank when the first outlet door is open and a balloon filled with gas connected to a top portion of the movable tank, wherein the balloon lifts the movable tank from a bottom position to a top position when the movable tank is empty.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 illustrates a power generating system with a filled movable tank in a top position according to an exemplary embodiment of the present disclosure;

FIG. 2 illustrates the power generating system with the movable tank in a bottom position according to an exemplary embodiment of the present disclosure;

FIG. 3 illustrates the power generating system with the movable tank in an intermediate position according to an exemplary embodiment of the present disclosure;

FIG. 4 illustrates the power generating system with an empty movable tank in the top position according to an exemplary embodiment of the present disclosure;

FIG. 5 is an exemplary flow chart of power generation process according to an exemplary embodiment of the present disclosure;

FIG. 6 illustrates exemplary input energy sources for a power generation system according to an exemplary embodiment of the present disclosure;

FIG. 7 is a block diagram illustrating an exemplary power controller according to certain embodiments of the present disclosure.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed embodiment(s). However, it will be apparent to those skilled in the art that the disclosed embodiment(s) may be practiced without those specific details. In some instances, well-known structures and components may be shown in block diagram form in order to avoid obscuring the concepts of the disclosed subject matter.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “proximate,” “minor,” and similar terms generally refer to ranges that include the identified value within a margin of 20%, 10% or preferably 5% in certain embodiments, and any values therebetween.

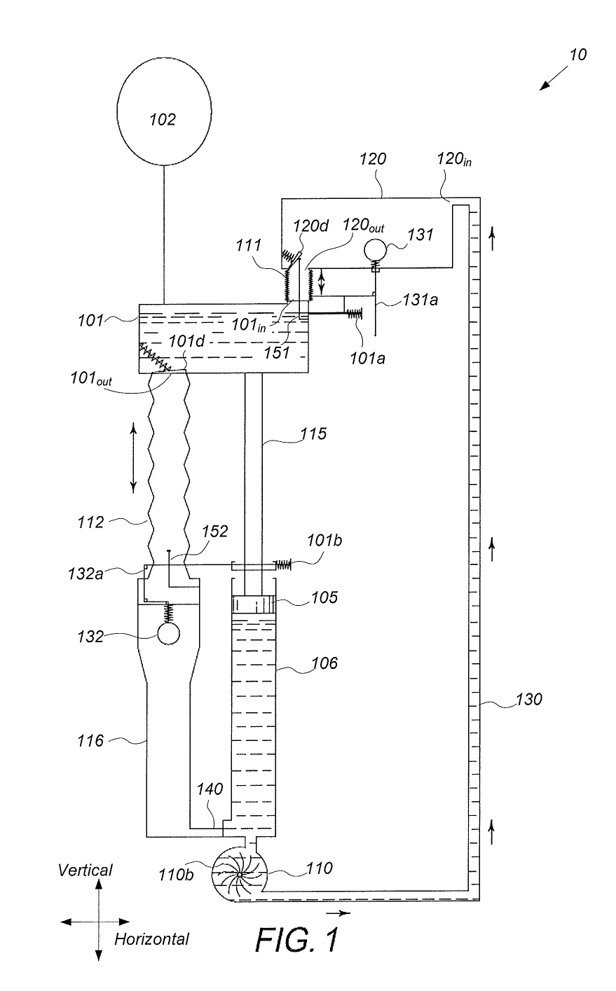

FIG. 1 illustrates a power generating system with a movable tank in top position according to an exemplary embodiment of the present disclosure. The power is generated by a power generating system 10 that includes a movable tank 101, a balloon 102, a piston 105 and a first cylinder 106, and a turbine 110. Furthermore, the system 10 includes flexibles tubes 111 and 112, a second cylinder 116, and a stationary tank 120.

The movable tank 101 is a storage tank having an inlet 101ᵢₙ on a top side and an outlet 101ₒᵤₜ at a bottom side. The movable tank 101 can be filled with a liquid (e.g., water) via the inlet 101ᵢₙ. The outlet 101ₒᵤₜ includes a first outlet door 101d that opens and closes the outlet 101ₒᵤₜ. The liquid in the movable tank 101 can be discharged from the outlet 101ₒᵤₜ by opening the first outlet door 101d. The first outlet door 101d can be spring actuated and operated mechanically. Alternatively or in addition, the first outlet door 101d can be electronically controlled.

The movable tank 101 is configured to move up and down in a vertical direction. Such a movement can be enabled in several ways, for example, the movable tank 101 can be attached with wheels or other sliding attachment that can slide up and down along a rail disposed vertically.

The bottom of the movable tank 101 is connected to the piston 105 driven by the movable tank 101 via a piston rod 115. As the movable tank 101 moves in the vertical direction, the piston 105 reciprocates in the first cylinder 106. The first cylinder 106 is filled with a liquid (e.g., water) and the piston is located at a top end above the liquid. The first cylinder 106 is also connected to the turbine 110 at a bottom end.

The turbine 110 includes a set of turbine blades 110a that rotate to produce power. The turbine 110 receives the liquid from the first cylinder 106, when the piston 105 moves downward in the first cylinder 106 ejecting the liquid onto the turbine blades 110a causing the turbine 110 to rotate and produce power. The rotation of the turbine blades 110a can be converted into electric energy via a generator (not illustrated). The electricity produced can be used for various purposes such as charging batteries, powering household devices such as bulbs, television, mixer, etc. Alternatively, the power produced by the turbine 110 can be used to compress air or move a load, for example, by connecting the turbine 110 to a jack. Several other utilities can be found to extract and use the power produced by the turbine 110. Further, the outlet of the turbine 110 is connected to the stationary tank 120 via a pipe 130.

The stationary tank 120 is a storage tank having an inlet 120ᵢₙ on a top side and an outlet 120ₒᵤₜ at a bottom side. The stationary tank 120 is located above the top position of the movable tank. The stationary tank 120 can be filled with a liquid (e.g., water) via the inlet 120ᵢₙ and the liquid can be discharged from the outlet 120ₒᵤₜ. The inlet 120ᵢₙ of the stationary tank 120 is connected to the outlet of the turbine 100 via the pipe 130 to receive the liquid from the turbine 110 when the movable tank descends.

The outlet 120ₒᵤₜ of the stationary tank 120 includes a second outlet door 120d that opens and closes the outlet 120ₒᵤₜ. The liquid in the stationary tank 120 can be discharged from the outlet 120ₒᵤₜ by opening the second outlet door 120d. The second outlet door 120d is spring actuated that is operated mechanically. Alternatively or in addition, the second outlet door 120d can be electronically controlled. Further, the outlet 120ₒᵤₜ of the stationary tank 120 is connected to the inlet 101ᵢₙ of the movable tank 101 via a first flexible tube 111 to discharge the liquid in the movable tank 101 when the second outlet door is open.

The system 10 further includes the second cylinder 116 connected to the movable tank 101 to receive the liquid from the outlet 101ₒᵤₜ of the movable tank 101 upon opening of the first outlet door 101d.

The movable tank 101 is also connected to the balloon 102 at the top side of the movable tank 101. The balloon 102 is filled with gas such as helium. The gas-filled balloon 102 is configured to lift the movable tank 101 from a bottom position to a top position when the movable tank 101 is empty.

The system 10 also includes a first lever 151 and a second lever 152 to open the outlet doors 120d and 101d, respectively. The first lever 151 and the second lever 152 can be a L-shaped bracket made of metal or other stiff material such as plastic. The first lever 151 is connected at the inlet 101ᵢₙ of the movable tank 101 and projects out of the inlet 101ᵢₙ. The first lever 151 can push the second outlet door 120d upward to open the second outlet door 120d when the movable tank 101 is at the top position. The second lever 152 is connected at the top end of the second cylinder 116. The second lever 152 can push the first outlet door 101d upward to open the outlet 101 of the movable tank 101 when the movable tank 101 reaches the bottom position.

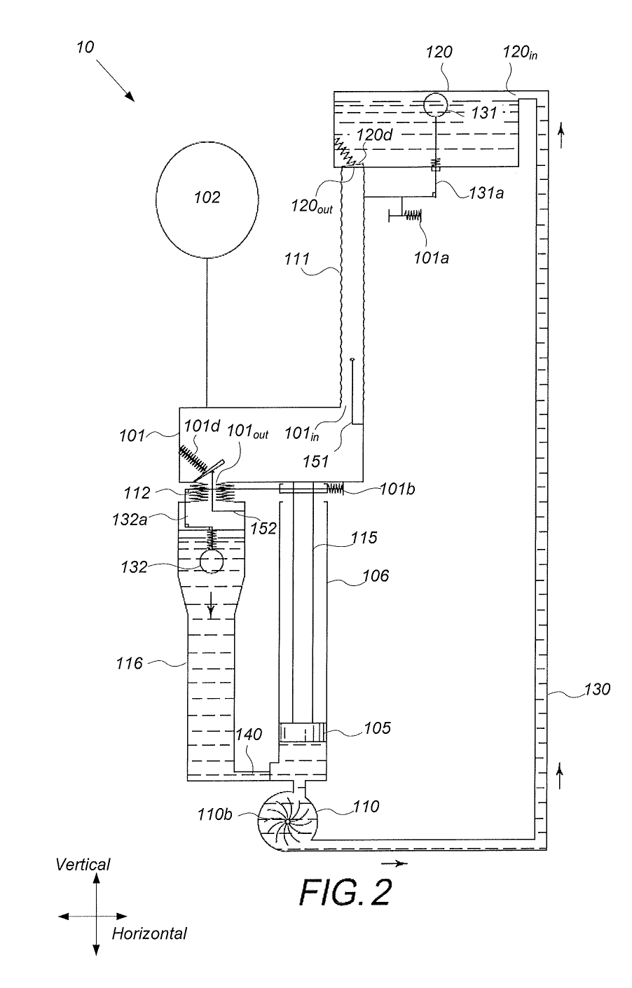

The system 10 also includes a locking and unlocking mechanism to lock the movable tank 101 in the top position (in FIG. 1) or the bottom position (in FIG. 2). The locking mechanism includes a top lock 101a and a bottom lock 101b. The top lock 101a engages with the movable tank 101 in the top position. The bottom lock 101b engages with the movable tank 101 when in the bottom position. The movable tank 101 is locked in the top position to prevent the movable tank 101 from moving downward until the liquid from the stationary tank 120 is completely discharged in the movable tank 101. Similarly, the movable tank 101 is locked in the bottom position to prevent the movable tank 101 from moving upward until the liquid from the movable tank 101 is completely discharged in the second cylinder 116.

The top lock 101a can be a spring loaded mechanically actuated lever. The actuation of the top lock 101a is provided by a top float 131, which is connected to the top lock 101a by, for example, a cable 131a. The top float 131 is a float that rises and falls as a liquid in the stationary tank 120 comes in contact with the top float 131. The top float 131 is located inside at the bottom of the stationary tank 120. When the top float 131 rises, it pulls the cable 131a causing the lever of the top lock 101a to retract away from the locked position (move toward the right) and disengage the top lock 101a to attain an unlocked state. When the top float 131 falls, the spring of the top lock 101a is released causing the lever to move toward the locked position (move to the left) and to engage the top lock 101a to attain a locked state.

Similarly, the bottom lock 101b can be a spring loaded mechanically actuated lever. The actuation of the bottom lock 101b is provided by a bottom float 132, which can be connected to the bottom lock 101b via a cable 132b. The bottom float 132 is a float located inside the second cylinder 116 that rises and falls as a liquid in the second cylinder 116 comes in contact with the bottom float 132. The bottom float 132 is located inside at the top end of the second cylinder 116. When bottom float 132 rises as the liquid level in the second cylinder rises 116, the bottom float 132 pulls a cable 132a causing a lever of the bottom lock 101b to retract away from the locked position (move towards right) and disengage the bottom lock 101b to attain an unlocked state. When the bottom float 132 falls, the spring of the bottom lock 101b is released causing the lever to move toward the locked position (move to the left) and engage the bottom lock 101b to attain a locked state.

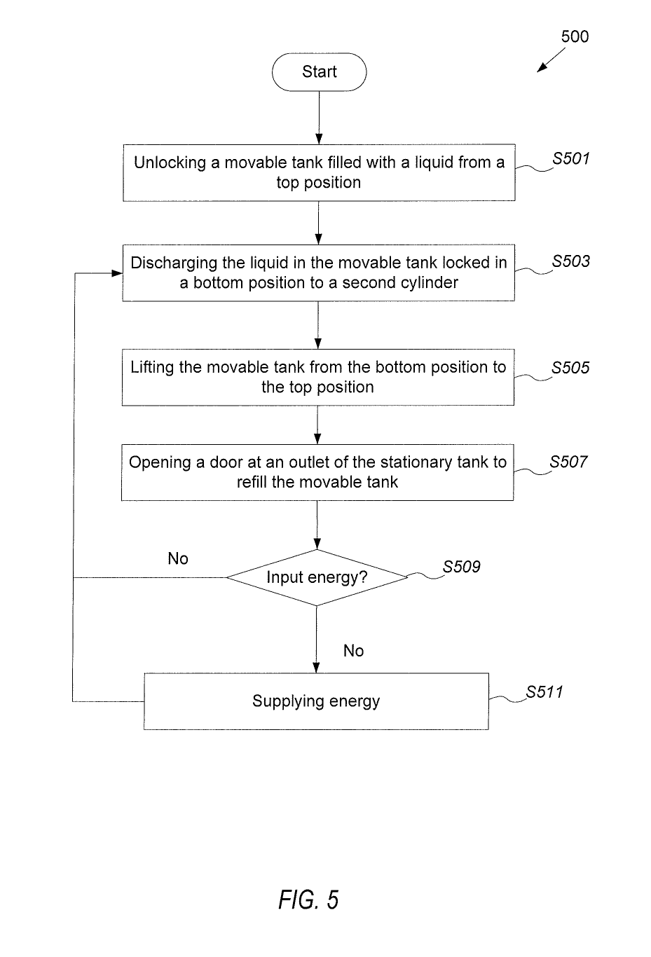

The system 10 can operate in multiple steps to produce power, as discussed with respect to FIG. 5 and illustrated in FIGS. 1, 2, 3, and 4. The steps in FIG. 5 form one cycle of a power generation process that can be repeated several times to produce power continuously. A power generation process 500 is illustrated in FIG. 5. The process 500 starts when a movable tank 101 of the power generating system 10 is at the top position. In step 501, the power generation is initiated. The movable tank 101 is filled with water and unlocked from the top position. The movable tank 101 moves downward to generate power at the turbine 110.

As shown in FIG. 1, step S501 is an initial stage or the power generation process 500. The movable tank 101 is filled with liquid and locked in the top position, the stationary tank 120 is empty, the first outlet door 101d is closed, and the piston 105 is at the top end of the first cylinder 106. The first cylinder 106 and the pipe 130 are filled with the liquid as well. Furthermore, the second cylinder 116 is empty, the second flexible tube 112 is in an extended state, and the first flexible tube 111 is in a compressed state. The first lever 131 keeps the second door 1120d open, as such the stationary tank 120 is empty and the top float 131 is at the bottom of the stationary tank 120.

At the end of the step 501, the top float 131 is at the bottom, the first lock 101a is unlocked and the movable tank 101 starts moving downward along with the balloon 102. The movable tank 101, filled with the liquid, moves downward due to the gravitational force, which is greater than an upward buoyant force exerted by the balloon 102. For example, the downward force exerted by the movable tank 101 can be 50 N while the buoyant force and the resistance offered by the piston 105 acting upward can be 25 N; as such the downward force is greater than the upward force causing the movable tank 101 to move downward. The shape and size of the movable tank 101, the amount of liquid filled in the movable tank 101, the balloon 102 filled with gas, and the first cylinder 106 can be designed such that the net downward force is greater than the upward force in the initial stage.

As the downward force is greater, the movable tank 101 starts pushing the piston 105 downward, forcing the liquid from the first cylinder 106 onto the blades of the turbine 110 causing the turbine 110 to rotate. The movable tank 101 continues to move downward until the movable tank 101 reaches the bottom position and is locked in the bottom position by the bottom lock 101b.

Referring back to FIG. 5, after step S501, step S503 is performed. At step S503, the movable tank 101 is locked in the bottom position and the liquid from the movable tank 101 is discharged into the second cylinder 116.

FIG. 2 illustrates step S503 of the power generation process 500 with the movable tank 101 in the bottom position according to an exemplary embodiment of the present disclosure. The movable tank 101 is at the bottom position and locked in position by the bottom lock 101b. When the movable tank 101 reaches the bottom position, the second lever 152 pushes opens the first outlet door 101d causing the liquid from the movable tank 101 to be discharged into the second cylinder 116.

As the second cylinder 116 starts filling with the liquid from the movable tank 101, the bottom float 132 rises upward as a liquid level in the second cylinder 116 rises and unlocks the bottom lock 101b when the movable tank 101 is empty.

Referring back to FIG. 5, at step S505, the movable tank 101 is empty and unlocked from the bottom position. As such, the movable tank 101 moves upward.

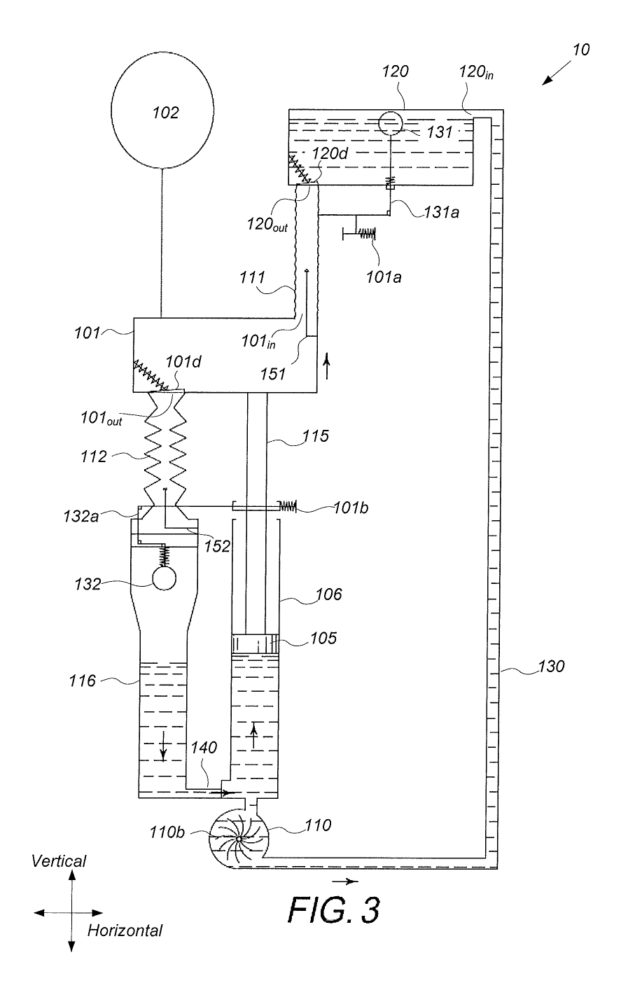

FIG. 3 illustrates the power generation system with movable tank in an intermediate position according to an exemplary embodiment of the present disclosure. The movable tank 101 is empty and is lifted in an upward direction by the balloon 102 due to buoyancy effect. As the movable tank 101 moves upward, the piston 105 moves upward as well. Further, the liquid from the second cylinder 116 is drawn into the first cylinder 106 via a one way valve (not illustrated) installed in a pipe 140 connecting the first cylinder 106 and the second cylinder 116. Thus, the first cylinder 106 is filled with the liquid as the piston 105 moves upward and the second cylinder 116 becomes empty. Further, the liquid in the stationary tank 120 causes the top float 131 to rise and keep the top lock 101a in a disengaged state. The turbine 110 may not rotate during the intermediate state.

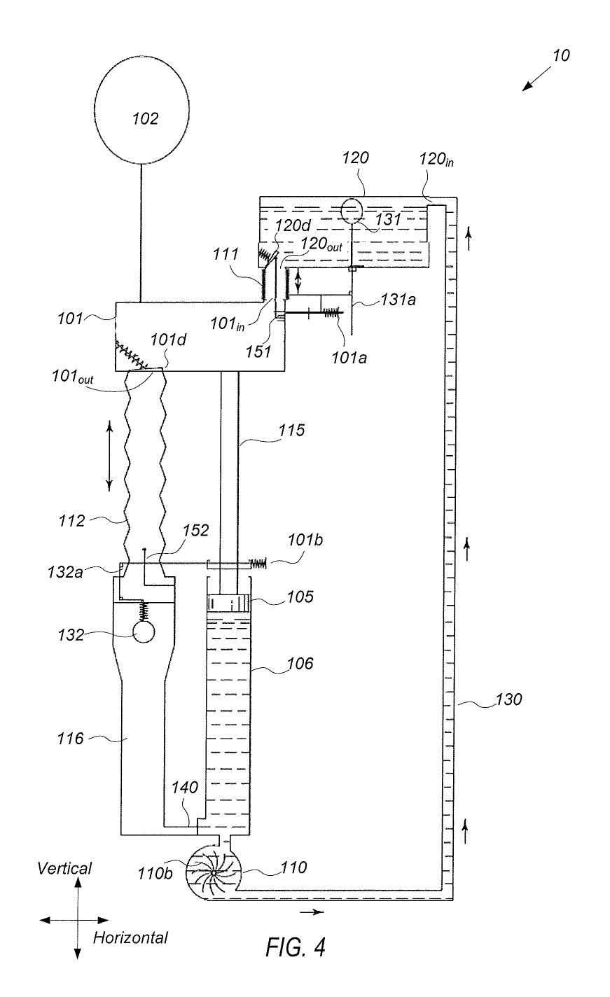

Referring back to FIG. 5, at step S507, the first lever 151 opens the second outlet door 120d of the stationary tank 120 and the movable tank 101 is refilled, as illustrated in FIG. 4.

FIG. 4 illustrates the power generation system with movable tank in the top position according to an exemplary embodiment of the present disclosure. When the empty movable tank 101 reaches the top position, the second outlet door 120d of the stationary tank 120 is opened and the liquid from the stationary tank 120 starts flowing to refill the movable tank 101 with the liquid. As the liquid flows, the liquid level falls in the stationary tank 120 causing the top float 131 to fall, which further causes the top lock 101a to lock the movable tank 101 in the top position.

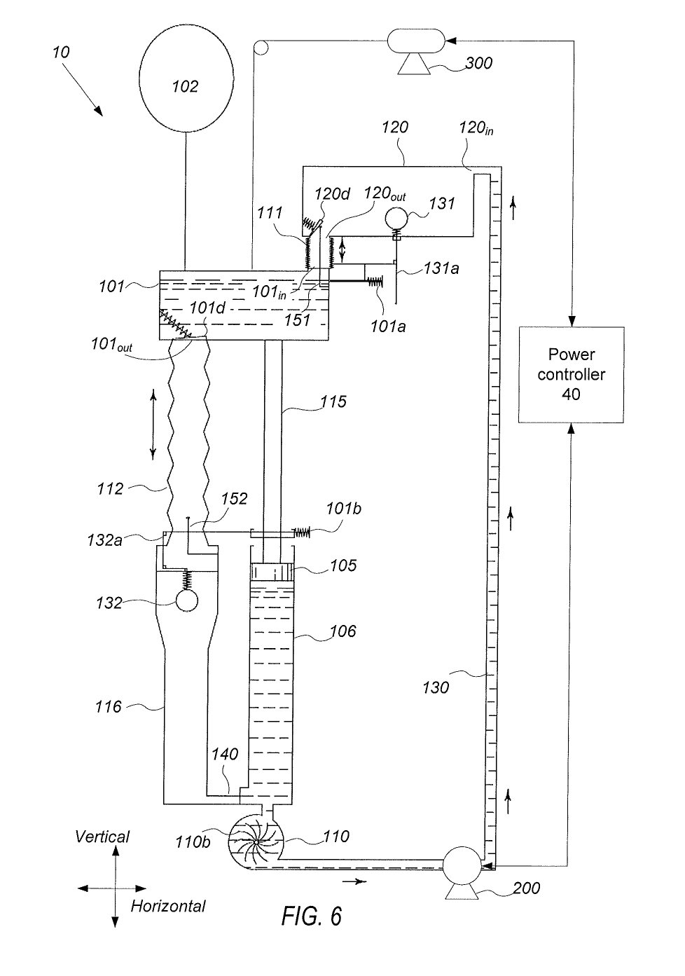

Referring back to FIG. 5, the cycle of steps 501, 503, 505 and 507 of the power generation process are continuously repeated, until the friction or other factors causes the power generating system 10 to slow down or stop. A determination of whether to supply external input energy can be made by a user based on the power generated or determined automatically using processing circuitry of a controller for an input energy source that can include a pump or motor, at step S509. If the determination is made to supply additional input energy, resulting in a “yes” at step 509, then the input energy is supplied at step S511. The input energy can be supplied by a pump 200 (illustrated in FIG. 6), which is connected to pipe 130 at the output side of the turbine 110. The pump 200 can supply energy to pump water into the stationary tank 120. Alternatively or in addition, the input energy can be provided by a motor 300 connected to a cable 301, which can be connected to a top portion of the movable tank 101. The motor 300 can drive the cable 301 causing the movable tank 101 to move upward to occupy the top position.

If external energy is not supplied, the process continues until friction causes the system 10 to stop, at which point external energy can be supplied to either push the movable tank 101 downward or upward, pump water into the stationary tank 120, or other appropriate input energy to restart the power generation process.

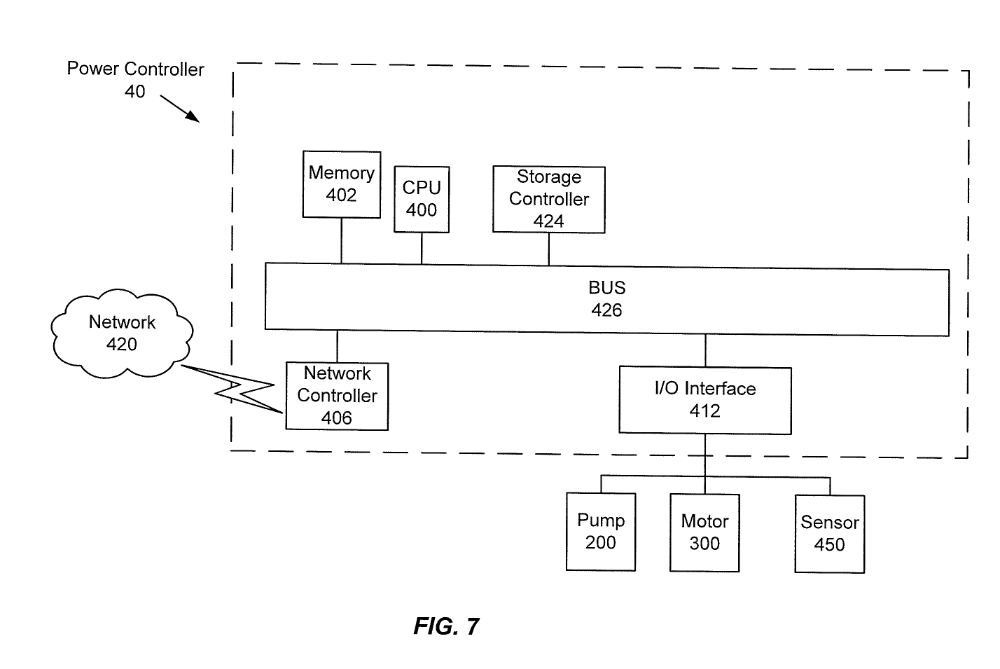

In one embodiment, at the step S509 of the process 500, the determination of whether to supply input energy can be made automatically based on one or more input energy criteria using a power controller 40, illustrated in FIG. 7. For example, the input energy criteria can be based on a velocity of the movable tank 101, a flow rate at the output of the turbine 110, or a power output by the power generating system 10. For example, the power generation system 10 can include sensors 450 such as a flow meter installed at the output of the turbine 110, a motion sensor or a velocity sensor installed on the movable tank 101, or other appropriate sensor to determine speed, or power output from the system 10. The sensor 450 can send signals to the power controller 40. A CPU 400 of the power controller 40 can process the sensor data to compare the processed data with a power input threshold such as a flow rate threshold, a speed threshold or a power output threshold. If the power input threshold is reached, the controller 40 can send an activation signal to the pump 300 or the motor 450 to activate the input energy source. The power input threshold can correspond to a minimum power output value such as approximately 10% of a power generation capacity. The speed or flow rate related thresholds can be predetermined by experimentation.

FIG. 7 is a block diagram illustrating an exemplary power controller 40 according to certain embodiments of the present disclosure. In FIG. 7, the power controller 40 includes a CPU 400 which can be configured to receive inputs from sensors 450, and process the data received from the sensors 450 to activate the pump 200 or the motor 300. The process data and instructions may be stored in the memory 402.

The hardware elements, in order to achieve the power controller 40, may be realized by various circuitry elements, known to those skilled in the art. For example, CPU 400 may be a XENON or Core processor from INTEL of America or an Opteron processor from AMD of America, or may be other processor types that would be recognized by one of ordinary skill in the art. Alternatively, the CPU 400 may be implemented on an FPGA, ASIC, PLD or using discrete logic circuits, as one of ordinary skill in the art would recognize. Further, CPU 400 may be implemented as multiple processors cooperatively working in parallel to perform the instructions of the processes described above with respect to FIGS. 4 and 5.

The power controller 40, in FIG. 7, also includes a network controller 406 for interfacing with a network 420. Such network based interfacing can be useful to send commands to an external device such as the pump 200 or the motor 300.

As can be appreciated, the network 420 can be a public network, such as the Internet, or a private network such as an LAN or WAN network, or any combination thereof and can also include PSTN or ISDN sub-networks. The network 420 can also be wired, such as an Ethernet network, or can be wireless such as a cellular network including EDGE, 3G and 4G wireless cellular systems. The wireless network can also be WiFi, BLUETOOTH, or any other wireless form of communication that is known.

An I/O interface 412 interfaces with the sensors 450, the pump 200 and the motor 300 to send and receive inputs or to send activation signal to the pump 200 or the motor 300.

The storage controller 424 connects the memory 402 with communication bus 426, which may be an ISA, EISA, VESA, PCI, or similar device, for interconnecting all of the components of the power controller 40. A description of the general features and functionality of the storage controller 424, network controller 406, and the I/O interface 412 is omitted herein for brevity as these features are known.

The power generation using the power generating system 10 has several advantages. The power generating system 10 operates on naturally occurring forms of energy particularly the gravitational and the buoyancy energy. As such, the power generating system 10 does not emit any harmful gases or other harmful materials that cause environmental pollution. The liquid used in the system 10 is recirculated within the system 10; hence no addition of the liquid is necessary during the power generation process. The power generating system 10 can be used to produce power in locations where solar, wind, hydro or other natural energy source are not available. The power generating system 10 can be installed above the ground or below the ground and does not need special settings that may be required in solar, wind or hydro power plants. For example, the solar power plants need an environment with exposure to sun for an extended period of time, and the solar panels should be configured to collect solar energy. The wind power plants require environment with high speed wind and wind turbines should be directed to intersect the path of the wind.

While certain embodiments have been described, these embodiments have been presented by way of example only, and are not intended to limit the scope of the present disclosure. Indeed, the novel apparatuses and systems described herein can be embodied in a variety of other forms; furthermore, various omissions, substitutions and changes in the form of the apparatuses and systems described herein can be made without departing from the spirit of the present disclosures. The accompanying claims and their equivalents are intended to cover such forms or modifications as would fall within the scope and spirit of the present disclosure.

What is claimed is:

1. A power generating system, comprising:
a movable tank filled with a liquid, the movable tank having an inlet and an outlet with a first outlet door and being configured to move in a vertical direction;
a piston driven by the movable tank via a piston rod as the movable tank moves from a top position to a bottom position in the vertical direction;
a first cylinder filled with the liquid, and connected to the piston at a top end and a turbine at a bottom end, wherein the piston reciprocates in the first cylinder pushing the liquid from the first cylinder into the turbine causing the turbine to rotate and produce power;
a stationary tank positioned at a location that is higher than the top position of the movable tank, the stationary tank having an inlet and an outlet with a second outlet door, wherein
the inlet of the stationary tank is connected to an outlet of the turbine to receive the liquid discharged from the turbine, and
the outlet of the stationary tank is connected to the inlet of the movable tank to discharge the liquid in the movable tank when the second outlet door is open;
a second cylinder connected to the movable tank and the first cylinder, wherein the second cylinder receives the liquid from the outlet of the movable tank when the first outlet door is open; and
a balloon filled with gas connected to a top portion of the movable tank, wherein the balloon lifts the movable tank from the bottom position to the top position when the movable tank is empty.

2. The system according to claim 1, further comprising:
a first lever connected at the inlet of the movable tank; and
a second lever connected at a top end of the second cylinder.

3. The system according to claim 2, wherein the first lever pushes open the second outlet door of the stationary tank when the movable tank is in the top position.

4. The system according to claim 3, wherein the movable tank receives the liquid from the stationary tank when the second outlet door of the stationary tank is open.

5. The system according to claim 2, wherein the second lever pushes open the first outlet door of the movable tank when the movable tank is in the bottom position.

6. The system according to claim 5, wherein the movable tank discharges the liquid to the second cylinder when the first outlet door of the movable tank is open.

7. The system according to claim 1, wherein the inlet of the movable tank is connected to the outlet of the stationary tank via a first flexible tube, wherein the first flexible tube provides a flow path for the liquid flowing from the stationary tank to the movable tank when the movable tank is in the top position.

8. The system according to claim 7, wherein the outlet of the movable tank is connected to a top end of the second cylinder via a second flexible tube, wherein the second flexible tube provides a flow path for the liquid flowing from the movable tank to the second cylinder when the movable tank is in the bottom position.

9. The system according to claim 1, wherein the second cylinder is connected to the first cylinder by a pipe having a one way valve allowing the liquid to flow from the second cylinder to the first cylinder.

10. The system according to claim 1, further comprising:
a top lock that engages with the movable tank in the top position;
a top float located inside the second cylinder at a bottom end of the second cylinder and connected to the top lock to engage or disengage the top lock;
a bottom lock that engages the movable tank in the bottom position; and
a bottom float located inside the second cylinder at a top end of the second cylinder and connected to the bottom lock to engage or disengage the bottom lock.

11. The system according to claim 10, wherein the top float moves downward as the liquid is discharged from the stationary tank causing the top lock to disengage when the liquid from the stationary tank is fully discharged into the movable tank.

12. The system according to claim 10, wherein the bottom float moves upward as the liquid is discharged from the movable tank into the second cylinder causing the bottom lock to disengage when the liquid from the movable tank is fully discharged into the second cylinder.

13. The system according to claim 12, wherein the liquid from the second cylinder is transferred to the first cylinder when the movable tank moves upward.

14. The system according to claim 1, wherein the first outlet door of the movable tank and the second outlet door of the stationary tank are spring loaded.

15. The system according to claim 1, further comprising:
an input energy source configured to supply input energy to the power generation system; and
a power controller including circuitry configured to
receive sensor data from one or more sensors indicating an effect of friction on the power generation system,
compare the sensor data to a power input threshold, and
output a control signal to activate the input energy source in response to determining that the sensor data exceeds the power input threshold.

16. The system according to claim 15, wherein the sensor data includes at least one of power sensor data, flow rate sensor data, and speed sensor data.

17. The system according to claim 15, wherein the input energy source includes at least one of a pump or a motor.

18. A method generating power with a power generation system, comprising:
unlocking a movable tank filled with a liquid having an inlet and an outlet with a first outlet door at a top position to allow the movable tank to move in a vertical direction from the top position to a bottom position, wherein
a downward movement of the movable tank causes movement of a piston within a first cylinder that forces the liquid stored in the first cylinder onto blades of a turbine to produce power;
receiving the liquid discharged from the turbine at a stationary tank located above the top position of the movable tank;
discharging the liquid into the movable tank locked at the bottom position through a second flexible tube into a second cylinder resulting in a rising liquid level in the second cylinder, wherein the rising liquid level contacts a float located inside the second cylinder that disengages a locking device on the movable tank;
lifting the movable tank in an unlocked state from the bottom position to the top position by a gas-filled balloon;
opening a door at an outlet of the stationary tank connected to an inlet of the movable tank by a first flexible tube, wherein the liquid flows from the stationary tank to the movable tank to refill the movable tank with the liquid; and
supplying input energy to the power generation system from an input energy source in response to determining that one or more input energy criteria are met.

19. The method according to claim 18, wherein the input energy is provided by a pump connected at the output of the turbine that pumps liquid to a stationary tank.

20. The method according to claim 18, wherein the input energy is provided by a motor that causes the movable tank to move upward.
